(19) United States
(12) Patent Application Publication
(10) Pub. No.: US 2023/0166226 A1
(43) Pub. Date: Jun. 1, 2023

(54) MONITORING SCHEME AND METHOD OF CORROSION AND FOULING REDUCTION FOR SCWO SYSTEM

(71) Applicant: 374Water Inc., Durham, NC (US)

(72) Inventors: Yaacov NAGAR, Durham, NC (US); David BALLENGHIEN, Romans-sure-lsere (FR); Marc DESHUSSES, Chapel Hill, NC (US); Hamutal HARIF, Durham, NC (US)

(21) Appl. No.: 18/059,850

(22) Filed: Nov. 29, 2022

Related U.S. Application Data
(60) Provisional application No. 63/284,474, filed on Nov. 30, 2021.
(60) Provisional application No. 63/284,470, filed on Nov. 30, 2021.

(51) Int. Cl. B01J 3/00; B01J 3/02; B01J 3/04; C02F 1/72

(52) U.S. Cl. CPC B01J 3/008; B01J 3/02; B01J 3/04; C02F 1/72; B01J 2204/002; C02F 2201/002

(57) ABSTRACT

A SCWO reactor fouling prevention and mitigation system that includes at least one feedstock tee which provides a feedstock to the SCWO reactor, at least one feedstock tee pressure sensor, such that each of the at least one feedstock tee has one of the at least one feedstock tee pressure sensor, at least one pressure sensor proximate a SCWO reactor inlet, and at least one pressure sensor proximate a SCWO reactor outlet. Also included is a controller which triggers a Clean In Place (CIP) procedure when there is a pressure difference between any two of the following, the SCWO reactor inlet, the at least one feedstock tee, and the SCWO reactor outlet. The CIP procedure includes washing a portion of the SCWO reactor with a fluid supplied through the at least one feedstock tee.

### RELATED APPLICATIONS

The present application is a Non-Provisional of, and claims 35 U.S.C. 119 priority from, U.S. Pat. Application Serial Nos. 63/284,474 and 63/284,470 filed Nov. 30, 2021, the entire contents of which are incorporated by reference herein.

### BACKGROUND

Waste processing remains an important priority in today’s society, and especially as it relates to waste which includes organic material. This waste includes sludge, which is a slurry, liquid waste, and waste with a large organic material component. One way of dealing with this waste is through treatment utilizing supercritical water oxidation (SCWO) technology. A reaction utilizing SCWO technology involves reacting the waste with air at temperatures and pressures above the critical point of water (374° C., 221 Bar) to convert all of the organic matter of the waste into clean water and CO₂ in a short period of time. Under these conditions, organic matter is typically oxidized at high reaction rates, resulting in complete conversion of the organic matter to CO₂, and usable water at reaction times as short as a few seconds.

The resulting water is divided into two streams, one mineral and one distilled water. The mineral stream contains suspended and dissolved inorganic minerals, and is optionally utilized as fertilizer, following further processing. One beneficial feature of using SCWO technology is that the continuous process utilizes the energy embedded in the waste. When the energy balance is positive, this feature allows the units to operate off-the-grid while increasing the system’s resiliency. Another benefit is that SCWO systems are more compact compared to other organic waste processing technologies. Further, it is possible to provide a system that normally does not require any reagents or consumables to operate, and that requires no additional external energy other than the initial energy embedded in the waste undergoing treatment and the initial heat provided to the system.

SCWO has been successfully applied to the destruction of problematic contaminants such as chemical weapons, PCBs, chlorinated solvents, coking wastewater, landfill leachate, oily wastes, PFAS, and dye-house wastewater. Unlike other hydrothermal treatment which generally produces an effluent liquid requiring additional processing prior to disposal, SCWO treatment yields relatively clean water. Moreover, formation of NOx, SOx, and other usual by-products of combustion is significantly reduced because of the relatively low process temperatures and water medium of the reaction and the unique properties of the medium in which the reaction takes place.

One drawback of current SCWO processes is that, for certain waste streams, especially those containing organic compounds with heteroatoms, strong acids are formed that can cause deterioration of the system materials of construction. Specifically, corrosion occurs within the components of the SCWO process, even when corrosion-resistant materials such as nickel-based alloys or titanium are used for construction. This is particularly the case in the high temperature zones, such as in the SCWO reactor or the heat exchangers. Accordingly, corrosion has been widely acknowledged as one of the main pitfalls of SCWO processes, limiting their applicability to feedstocks with little or no organic compounds which include heteroatoms, or requiring the use of expensive construction materials within the SCWO process.

Additionally, despite the high-pressure within the SCWO reactor, mineral salts that are initially soluble at ambient temperature will experience a substantial solubility decrease around the critical temperature. Typically, there is minimal solubility above 400-450° C. In particular, most water-soluble salts exhibit a behavior where their solubility drops by several orders of magnitude in a temperature range of a few tens of degrees C around the critical temperature of water (374° C.). For instance, the solubility of Na₂SO₄ in water at 320° C. (25 MPa) is roughly 100,000 mg/L, whereas it drops to roughly 1 mg/L at 410° C.

This high temperature insolubility can become an issue when the newly formed salts precipitate in the reactor and/or in other parts of the process, causing fouling and ultimately leading to costly downtimes. Salt precipitation and process fouling has been widely acknowledged as one of the main pitfalls of SCWO processes, restricting the type and composition of waste that this technology can successfully treat. Accordingly, there is the need for an improved SCWO process that reduces the corrosion caused by acidic and/or acid forming feedstocks and the fouling that results from precipitates within the SCWO reactor.

### SUMMARY

The above-listed need is met or exceeded by the present monitoring scheme and method for corrosion and fouling reduction for supercritical water oxidation (SCWO) systems. Specifically, the monitoring scheme is based on pressure drop monitoring at any location along the SCWO reactor. In a preferred embodiment, the monitoring scheme is designed to detect and diagnose pressure trends, for offsetting conditions across feedstock tees, where the pressure at the SCWO reactor outlet is compared to the pressure at either the SCWO reactor inlet or the pressure at a section within the SCWO reactor following any of the feedstock tees or at a baseline pressure. Preferably, the monitoring scheme measures pressure drops across feedstock tees. Additionally, the monitoring scheme measures the pressure difference for sections within the SCWO reactor following any feedstock tee.

In particular, when a controller of the present monitoring scheme for corrosion and fouling control detects a large pressure difference between the SCWO reactor outlet and either any of the SCWO reactor sections following one of the feedstock tees or the SCWO reactor inlet, the controller triggers a Clean In Place (CIP) procedure. Alternatively, for SCWO systems that include a plurality of feedstock tees, a large pressure drop between any of the SCWO reactor sections following two feedstock tees also triggers the CIP procedure. A pressure drop within the SCWO reactor indicates fouling within the SCWO reactor.

Fouling within the SCWO reactor restricts the fluid flow through the SCWO reactor, increasing pressure within the SCWO reactor upstream of the fouling. Accordingly, the present monitoring scheme for corrosion and fouling control reduces plugging or damage to the reactor and downstream equipment by reducing fouling in the SCWO reactor.

Additionally, an important feature of the CIP procedure is locally lowering the temperature in the reactor, thereby triggering redissolution of salt precipitates without stopping the SCWO reactor operation. In the presently disclosed SCWO process, feedstock streams are optionally preheated to roughly 100-300° C. At this temperature range, most inorganic compounds will become or remain soluble. The feedstock streams are then added to the SCWO reactor where they undergo an oxidation reaction, resulting in a rapid temperature increase and water phase change.

The rapid temperature change occurs in two steps. First, through the mixing of the mildly preheated feedstock (100-300° C.) with the hot fluid in the SCWO reactor. In particular, air is supplied at the first supply tee, while water and reacted by-products are supplied in subsequent tees. The resulting temperature, also referred to as the mixing temperature, depends on the flow rate ratios, but is meant to be around 300° C. -600° C. Additionally, the feedstock flow rate is controlled to achieve the desired mixing temperature. There is not necessarily water phase change at that temperature, as the transition from subcritical to supercritical is continuous. However, the transition from subcritical to supercritical does occur during that first temperature increase step. Second, the oxidation reaction then results in a rapid temperature change from approximately 300° C. up to 650° C.

The temperature evolution pattern triggers the once solubilized inorganic compounds to precipitate out of solution. Importantly, triggering the CIP process helps reduce fouling in the SCWO reactor by locally decreasing the temperature within the SCWO reactor so that the inorganic compounds become soluble again while maintaining overall SCWO reactor operation.

Another feature of the present disclosure is the method for conducting the CIP process. Preferably, for SCWO reactors that include several feedstock tees, a stream of a fluid that is at a temperature lower than the temperature within the reactor is injected into the reactor at one of the feedstock tees. In this way, the local temperature within the SCWO reactor is reduced rapidly by introduction of the lower temperature fluid. However, the temperature within the remainder of the SCWO reactor is sufficiently high so that proper reaction takes place. As such, the CIP procedure does not impair the operation of the SCWO reactor. A preferred lower temperature fluid is water which optionally includes at least one additive, or a feedstock with a low calorific value.

In particular, the present monitoring scheme does not impair operation of the SCWO reactor in large part because the temperature within the SCWO reactor nearest the outlet maintains the required reaction temperature regardless of whether other sections of the SCWO reactor are experiencing the CIP procedure. This is preferably accomplished by providing co-fuel to any or all of the remaining feedstock tees, and by maintaining the desired residence time in the SCWO reactor. Alternatively, a sufficiently large quantity of co-fuel is optionally provided only to the feedstock tee downstream of the feedstock tee where the CIP procedure is taking place. In particular, the addition of co-fuel increases the calorific value of the feedstock, thereby offsetting loss of heat due to the CIP procedure.

Another feature of the present disclosure is the ability to control the extent of the washing caused by the CIP procedure. In particular, the flow rate of the lower temperature fluid is adjustable to achieve the desired reduction in temperature within the SCWO reactor. By increasing the flow rate of the lower temperature fluid into the SCWO reactor, the CIP procedure lowers the temperature within the SCWO reactor to a greater extent. Additionally, the duration of the CIP procedure is adjustable to achieve the desired reduction in temperature within the SCWO reactor. Specifically, increasing the duration of the CIP procedure increases the distance within the SCWO reactor that the reduced temperature persists.

Further, additives are optionally added to the lower temperature fluid for faster cleaning and to reduce the reprecipitation of the minerals further within the SCWO reactor. Potential additives include inert particles acting as seeding nuclei, mild acids, and/or chelating agents which promote dissolution of the deposited salts. Also, inert particles acting as seeding nuclei provide a surface area upon which salts preferentially precipitate.

Another important feature of the present disclosure is the optional application of at least two and preferably three different additives to reduce corrosion and fouling within the SCWO reactor. The additives are optionally added to the lower temperature fluid during the CIP procedure. Alternatively, the additives are optionally continuously added to the feedstock during normal operation of the SCWO reactor, regardless of whether or not a CIP procedure is taking place.

In particular, a first additive includes a neutralizing agent that reacts with the acids within the feedstock and with acids which form during the reaction of the feedstock within the SCWO reactor to reduce corrosion in the SCWO reactor. For example, feedstock often includes organic compounds with chloride atoms, where the chloride atoms react to become hydrochloric acid during the reaction process. The first additive preferably includes finely powdered or solubilized alkaline metals or alkaline-earth metals species such as metal oxides (MₓO_{y}), hydroxides, metal carbonates, metal phosphates or combinations thereof.

A second additive is a blend of seeding nuclei, which optionally take the form of suspended inert particles of metal oxides such as silica SiO₂, iron oxide Fe₂O₃, alumina Al₂O₃ or silt. The second additive offers an available, free moving surface area to which the newly formed compounds or salts preferably attach when precipitating out of solution. Therefore, the compounds or salts that attach to the second additive do not foul the SCWO reactor.

A third additive is a thickener, such as a starch or cellulose, which creates a stable and homogenous suspension or matrix within the slurry feed or within an inlet liquid containing the additives, which is added to the slurry feed. As a result, a stable and homogenous suspension is obtained, which helps control the concentration of the additives. Specifically, the thickener helps convert solid powders into a stable, homogenous, and pumpable liquid for smooth addition to the main feedstock stream.

Preferably, the thickener is added when insoluble particles are used in the feedstock. Additionally, a mixer, such as a static mixer, is optionally included where the additive matrix is added to the feedstock stream, to achieve improved mixing efficiency of the thickener with the feedstock.

Another feature of the present disclosure is the ability to feed the additive streams to the SCWO reactor as part of the feedstock tees or in separate tees that lead to the SCWO reactor. In this way, the additives mix with the feedstock either before reaching the SCWO reactor or within the SCWO reactor.

Yet another feature of the present disclosure is a metering and monitoring system for providing the additives to the SCWO reactor. In particular, a pH sensor is optionally located at the effluent outlet of the SCWO process which is located downstream of an outlet of the SCWO reactor and is used to monitor the effectiveness of the additives. Further, a control unit associated with the pH sensor monitors the pH of the effluent leaving the SCWO reactor and triggers an increase in dosing of the neutralizing agents if the pH value falls below a particular value. Conversely, when the pH of the effluent increases above a certain point, the control unit decreases the dosing of the neutralizing agent supplied to the SCWO reactor. Additionally, the metering and monitoring system optionally includes color sensors, Oxidation Reduction Potential (ORP) sensors, Ion Selective Electrode (ISE) sensors, pressure sensors, conductivity probes, CO₂ sensors, and/or oxygen sensors.

Still another feature of the present disclosure is the optional separator located downstream of the SCWO reactor. In particular, the separator allows for recovery of the inert particles and/or the accumulated salts from the SCWO reactor effluent. Moreover, the inert nuclei are often coated with insoluble salts. In particular, if the coating is a soluble salt, then the salt will dissolve within the SCWO reactor effluent once the effluent drops below the critical temperature. However, if the coating is insoluble, then removing or milling the coating is needed for recycling or to reduce discarding of the additive inert particles.

As a result, the provided separator optionally recycles particles back into the process. Importantly, the classification of which particles are reusable is performed according to a target diameter or specific gravity of the particles, and the separation is preferably conducted using a screening filter, hydrocyclone or other similar method.

More specifically, an embodiment of the present disclosure is a SCWO reactor fouling prevention and mitigation system that includes at least one feedstock tee which provides a feedstock to the SCWO reactor, at least one feedstock tee pressure sensor, such that each of the at least one feedstock tee has one of the at least one feedstock tee pressure sensor, at least one pressure sensor proximate to a SCWO reactor inlet, and at least one pressure sensor proximate to a SCWO reactor outlet. Also included is a controller which triggers a Clean In Place (CIP) procedure when there is a pressure difference between any two of the following, the SCWO reactor inlet, the at least one feedstock tee; and the SCWO reactor outlet. The CIP procedure includes washing a portion of the SCWO reactor with a fluid supplied through the at least one feedstock tee.

In a preferred embodiment, the at least one feedstock tee includes four feedstock tees and the at least one pressure sensor includes four pressure sensors, such that the CIP procedure takes place at one of the four feedstock tees other than the feedstock tee nearest the outlet of the SCWO reactor. Preferably, the washing fluid is water or any other appropriate fluid as is known in the art.

In another preferred embodiment, the SCWO reactor fouling prevention and mitigation system also includes at least one additive supplied through the at least one feedstock tee. The at least one additive includes at least one of a neutralizer for reducing the acidity within the SCWO reactor, a blend of seeding nuclei for attaching to particulates within the SCWO reactor; and a thickener for maintaining a stable and homogenous feed into the SCWO reactor.

In yet another preferred embodiment, the SCWO reactor fouling prevention and mitigation system also includes a metering system connected to the controller which controls the supply of the at least one additive to the at least one feedstock tee, where the metering system has at least one sensor selected from a group of sensors including: pH sensors, color sensors, Oxidation Reduction Potential (ORP) sensors, Ion Selective Electrode (ISE) sensors, conductivity probes, CO₂ sensors, and/or oxygen sensors; and a flow regulator for each of the at least one additive, wherein the flow regulator adjusts the amount of the at least one additive to the at least one feedstock tee based on the data received from the at least one sensor.

A preferred embodiment also includes a blender upstream of the at least one feedstock tee, such that the blender mixes the at least one additive with the feedstock prior to reaching the SCWO reactor. Preferably, included is a heat exchanger located between the blender and the SCWO reactor which preheats the at least one additive and the feedstock. In another preferred embodiment, any of the feedstock tees downstream of the feedstock tee where the CIP procedure is taking place receives a co-fuel to increase the heating value within the SCWO reactor downstream of the location of the CIP procedure.

A second embodiment of the present disclosure is a method of corrosion and fouling reduction for a SCWO system which includes providing a feedstock to a SCWO reactor, and introducing at least two additives into the SCWO reactor, the at least two additives including a neutralizer for reducing the acidity within the SCWO reactor, a blend of seeding nuclei for particulates to attach to within the SCWO reactor, and a thickener for maintaining a stable and homogenous feed into the SCWO reactor. The method also includes measuring, with at least one sensor, at least one parameter of the SCWO reactor, and adjusting the amount of the at least two additives into the SCWO reactor based on the parameter.

In a preferred embodiment, the method also includes separating, with a separator, the seeding nuclei from the particulates; and recycling the seeding nuclei. Preferably, the separator includes at least one hydrocyclone.

In another preferred embodiment, the method also includes washing a portion of the SCWO reactor, such that the washing includes measuring the pressure at two locations within the SCWO reactor, determining, based on the measured pressure, whether the pressure drop exceeds a threshold value; and introducing a washing fluid to reduce the temperature within the portion of the SCWO reactor and dissolve salt precipitates.

Preferably, the feedstock and the at least two additives are provided to the SCWO reactor by at least two feedstock tees, which are spaced along the length of the SCWO reactor. Preferably still, the at least two feedstock tees are spaced evenly along the length of the SCWO reactor

In yet another preferred embodiment, the at least one parameter includes an ORP of a SCWO reactor effluent measured by an ORP sensor, a pH of the SCWO reactor effluent measured by a pH sensor, a color of the SCWO reactor effluent detected by a color sensor, an oxygen content of the SCWO reactor effluent measured by an oxygen sensor, a conductivity of the SCWO reactor effluent measured by a conductivity probe, an ion content of the SCWO reactor effluent measured by an ISE sensor; and a CO₂ content of the SCWO reactor effluent measured by a CO₂ sensor.

A third embodiment of the present disclosure includes a SCWO Multiple Feeds Injection (MFI) reactor fouling prevention and mitigation system, which include a SCWO reactor, at least one feedstock tee which provides a feedstock to the SCWO reactor, and a metering system. The metering system has at least one flow regulator which regulates the flow of at least one additive, the at least one additive including at least one of a neutralizer for reducing the acidity within the SCWO reactor, a blend of seeding nuclei for particulates to attach to within the SCWO reactor; and a thickener for maintaining a stable and homogenous feed into the SCWO reactor. The SCWO reactor fouling prevention and mitigation system also includes at least one sensor which relays measured data to a controller which communicates with the metering system to control the at least one flow regulator.

In a preferred embodiment, the at least one sensor includes an ORP sensor which measures an ORP of a SCWO reactor effluent, a pH sensor which measures a pH of the SCWO reactor effluent, a color sensor which detects a color of the SCWO reactor effluent, an oxygen sensor which measures an oxygen content of the SCWO reactor effluent, a conductivity probe which measures a conductivity of fluid within the SCWO reactor, an ISE sensor which measures an ion content of the fluid within the SCWO reactor, and a CO₂ sensor which measures a CO₂ content of the SCWO reactor effluent.

In another preferred embodiment, the SCWO reactor fouling prevention and mitigation system includes a controller which triggers a Clean In Place (CIP) procedure when there is a pressure difference between any two of the following, an inlet of the SCWO reactor, the at least one feedstock tee, and an outlet of the SCWO reactor. Preferably, the CIP procedure includes washing a portion of the SCWO reactor with a fluid supplied through the at least one feedstock tee.

In preferred embodiments, a separator separates the seeding nuclei from the particulates and at least one heat exchanger preheats at least one of the at least one additive, and the feedstock. In yet another preferred embodiment, the at least one feedstock tee includes four feedstock tees and the at least one pressure sensor includes four pressure sensors. In another preferred embodiment, any of the feedstock tees downstream of the feedstock tee where the CIP procedure is taking place receives a co-fuel to increase the heating value within the SCWO reactor downstream of the location of the CIP procedure unless the CIP procedure takes place at the feedstock tee nearest the outlet of the SCWO reactor.

### BRIEF DESCRIPTION OF THE DRAWINGS

FIG. 1 is a schematic of the present monitoring scheme for corrosion and fouling reduction for SCWO systems.

FIG. 2 is a graph showing the nominal temperature profile in a SCWO reactor which does not implement a CIP procedure by the present monitoring scheme for corrosion and fouling reduction for SCWO systems.

FIG. 3 is a graph showing the nominal temperature profile in a SCWO reactor which does implement the CIP procedure by the present monitoring scheme for corrosion and fouling reduction for SCWO systems.

FIG. 4 is a decision flow diagram showing the control philosophy for implementing the CIP procedure by the present monitoring scheme for corrosion and fouling reduction for SCWO systems.

FIG. 5 is a schematic of an alternate embodiment of the present monitoring scheme for corrosion and fouling reduction for SCWO systems which includes a first additive and a second additive.

FIG. 6 is a schematic of an alternate embodiment of the present monitoring scheme for corrosion and fouling reduction for SCWO systems which includes a first additive, a second additive, and a third additive.

FIG. 7 is a schematic of an alternate embodiment of the present monitoring scheme for corrosion and fouling reduction for SCWO systems which includes additive tees and feedstock tees.

FIG. 8 is a schematic of an alternate embodiment of the present monitoring scheme for corrosion and fouling reduction for SCWO systems which includes a separator and recycling of additives.

FIG. 9 is a schematic of a separator used in the present monitoring scheme for corrosion and fouling reduction for SCWO systems.

### DETAILED DESCRIPTION

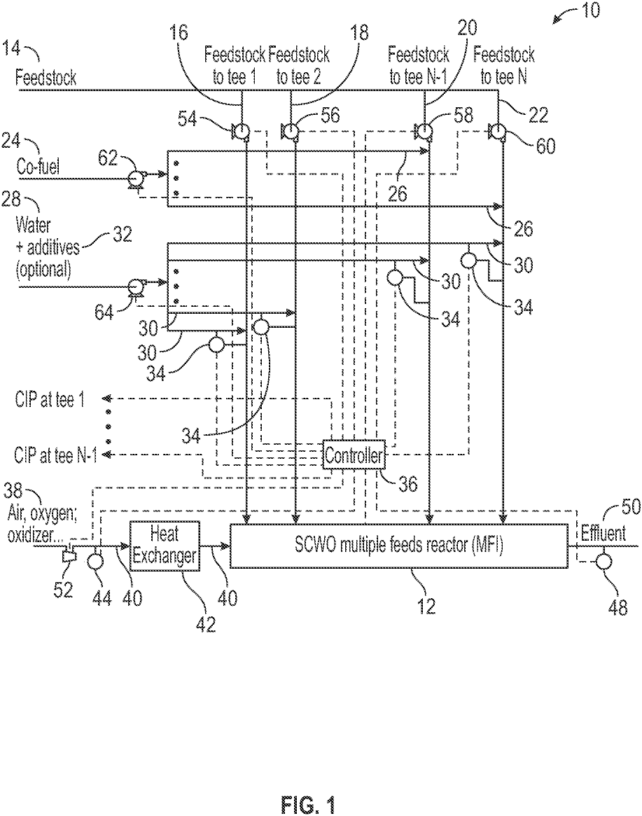

Referring now to FIG. 1, the present corrosion and fouling reduction system for supercritical water oxidation (SCWO) apparatus is generally designated 10 and includes a SCWO reactor 12. While the present SCWO system 10 preferably includes a SCWO multiple feeds injection (MFI) reactor 12, it is understood that any SCWO reactor is optionally used as is known in the art. Additionally, feedstock 14 is provided to the SCWO reactor 12 by a given number of feedstock tees. In the example shown in FIG. 1, there are four feedstock tees 16, 18, 20, 22. However, it is understood that any number of feedstock tees are contemplated for providing feedstock 14 to the SCWO reactor 12. It is preferred that the monitoring scheme and fouling reduction system 10 includes between two and ten feedstock tees.

Additionally, the feedstock tees 16, 18, 20, 22 are spaced apart to provide the feedstock 14 to the SCWO reactor 12 at various locations within the SCWO reactor 12. Each feedstock tee 16, 18, 20, 22 optionally includes a heat exchanger (not shown) which preheats the feedstock 14. Preferably, the feedstock 14 is preheated to roughly 100-300° C. in each feedstock tee 16, 18, 20, 22.

Before reaching the SCWO reactor 12, co-fuel 24 is supplied to the feedstock tees 20, 22 by co-fuel supply lines 26. The co-fuel 24 is a chemical with a high calorific value, which is fed to the process in a minimal amount to complement the feedstock’s 14 calorific value. The co-fuel 24 is mixed with the feedstock 14 or is supplied to the SCWO reactor 12 separately. Typical examples of the co-fuel 24 include alcohols, hydrocarbons, neat compounds or blends. Waste streams such as grease, spent motor oils, and spent lubricating fluid are also appropriate for use as the co-fuel 24. While FIG. 1 depicts co-fuel 24 being added only to feedstock tees 20, 22, it is understood that the co-fuel 24 is optionally added to any of the feedstock tees 16, 18, 20, 22 as needed to control the supply of co-fuel 24 into the SCWO reactor 12. In particular, the co-fuel 24 is supplied to the feedstock tees 16, 18, 20, 22 in order to compensate for the reduced temperature within the SCWO reactor 12 that results from the implementation of the Clean In Place (CIP) procedure.

Similarly, water 28 is provided to the feedstock tees 16, 18, 20, 22 by water supply lines 30. While the preferred embodiment includes water 28 which is supplied by the water supply line 30, it is understood that any appropriate fluid could be used in place of water 28 as is known in the art. Water 28 is provided to the SCWO reactor 12 as part of the CIP procedure. Specifically, water 28 is used to wash a portion of the SCWO reactor 12. However, any appropriate fluid is optionally used in place of the water 28 for the CIP procedure as is known in the art.

Though the water supply lines 30 are depicted as being downstream of the co-fuel supply lines 26, it is understood that the water supply lines 30 are optionally located upstream of the co-fuel supply lines 26. As discussed in greater detail below, an optional additive 32 is added to the feedstock 14 by the water supply lines 30.

Another important feature of the present monitoring scheme and fouling reduction system 10 is the inclusion of a plurality of water supply line pressure sensors 34 located within the water supply lines 30. These pressure sensors 34 measure the pressure of the supplied water 28 and optionally added additives 32 which are supplied to the feedstock pressure tees 16, 18, 20, 22. Alternatively, the pressure sensors 34 measure the pressure within the feedstock tees 16, 18, 20, 22 downstream of the water supply lines 30. In this way, the pressure sensors 34 either measure the pressure of the water 28 and optional additive 32, or the pressure of the feedstock 14, co-fuel 24, water 28 and optional additive 32 within the feedstock tees 16, 18, 20, 22 upstream of the SCWO reactor 12.

Importantly, the pressure sensors 34 relay the measured pressure values to a controller 36. Further, an oxidant 38 is supplied to the SWCO reactor 12 by way of an oxidant supply line 40. The oxidant 38 is contemplated as being air, pure oxygen, or other forms of oxidant as are known in the art. Optionally included in the oxidant supply line 40 is a heat exchanger 42 which preheats the oxidant 38. Moreover, an oxidant pressure sensor 44 is provided in the oxidant supply line 40 and measures the pressure of the supplied oxidant 38. The oxidant pressure sensor 44 relays the measured pressure to the controller 36.

Further, an effluent pressure sensor 48 measures the pressure of an effluent 50 of the SCWO reactor 12. It is contemplated that the effluent 50 is optionally used to preheat the oxidant 38 through the heat exchanger 42. Additionally, the feedstock 14, co-fuel 24, water 28, and additive 32 are optionally stored in tanks (not shown) or otherwise stored as is known in the art. Preferably, the oxidant 38 is supplied to the SCWO reactor 12 by way of a compressor 52. While FIG. 1 depicts the compressor 52 as being downstream of the heat exchanger 42, it is contemplated that the compressor 52 is optionally located at any location along the oxidant supply line 40.

Moreover, flow of the feedstock 14, co-fuel 24, water 28, and optional additive 32 are each controlled by fluid flow devices such as valves, pumps, or other devices which regulate the flow of fluid. For example, the feedstock tees 16, 18, 20, 22 optionally include flow regulating devices 54, 56, 58, 60, respectively, which are connected to the controller 36 to control the flow of feedstock 14 to the SCWO reactor 12. It is contemplated that the flow regulating devices 54, 56, 58, 60 are either upstream or downstream of where the co-fuel 24, water 28, and additive 32 are supplied to feedstock tees 16, 18, 20, 22.

Additionally, a co-fuel flow regulating device 62, as well as a water and additive flow regulating device 64 are connected to the controller 36. It is also contemplated that the flow regulating devices 62, 64 are located within the water supply lines 30 leading to each feedstock tee 16, 18, 20, 22.

In a preferred embodiment, flow regulating devices 54, 56, 58, 60, 62, 64 are variable flow rate pumps. As discussed in greater detail below, the controller 36 adjusts the flow rate for each of the feedstock 14, co-fuel 24, water 28, and optional additive 32 as needed to implement the CIP procedure.

When the CIP procedure is triggered, the controller 36 shuts off the flow of feedstock 14 to one of the feedstock tees 16, 18, 20, 22. Then, the controller 36 increases the flow of water 28 and optional additive 32 to the same feedstock tee 16, 18, 20, 22 that is no longer providing feedstock 14. In doing so, the controller 36 implements the CIP procedure by washing a portion of the SCWO reactor 12 following one of the feedstock tees 16, 18, 20, 22 to a sufficiently low temperature so that the particulates within the fluid flowing in the SCWO reactor 12, or the scales, salts, or minerals deposited in the SCWO reactor, dissolve. In particular, the flow rate of the water 28 is adjustable to achieve the desired reduction in temperature within the SCWO reactor 12. By increasing the flow rate of the water 28 into the SCWO reactor 12, the CIP procedure lowers the temperature within the SCWO reactor 12 to a greater extent. Increasing the duration of the CIP procedure increases the distance within the SCWO reactor 12 that the washing takes place.

In a preferred embodiment, the system 10 increases the heating value for any of the feedstock tees 16, 18, 20, 22 downstream of the feedstock tee 16, 18, 20, 22 which is performing the CIP procedure to compensate for the washing caused by the CIP procedure. A preferred way to increase the heating value of the feedstock tee 16, 18, 20, 22 is through the addition of an increased quantity of co-fuel 24. For example, if feedstock tee 16 is conducting the CIP procedure, then feedstock tee 18 will receive additional co-fuel 24 to compensate for the washing taking place after feedstock tee 16. Alternatively, the feedstock tees 20 and 22 optionally receive additional co-fuel 24 as well.

Additionally, temperature sensors (not shown) are optionally included in each of the feedstock tees 16, 18, 20, 22, in the oxidant supply line 40, and at an outlet of the SCWO reactor 12. These temperature sensors relay the measured temperature to the controller 36 to help the controller 36 accurately adjust the flow rate of the co-fuel 24.

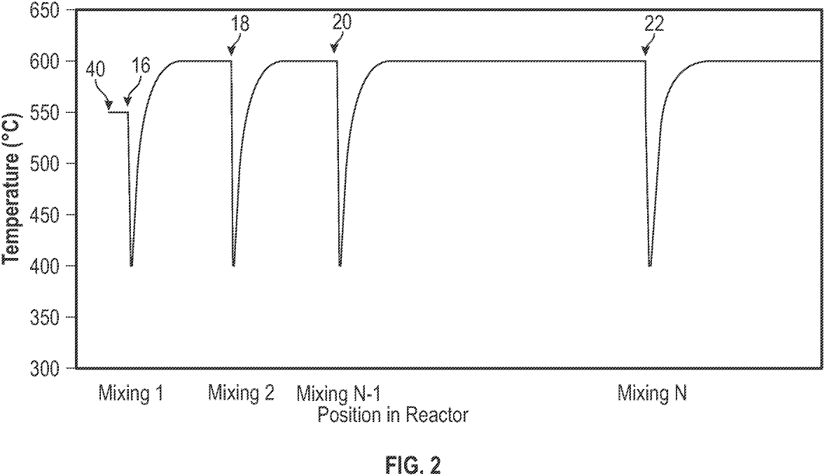

FIG. 2 depicts a graph which shows the nominal temperature profile in a SWCO reactor 12 which does not implement the CIP procedure by the present monitoring scheme and fouling reduction system 10. In particular, the graph shows the temperature within the SCWO reactor 12 as a function of location within the SCWO reactor 12. Moreover, the vertically oriented downward pointing arrows indicate the location of the feedstock tees 16, 18, 20, 22 within the SCWO reactor 12. At each of the feedstock tees 16, 18, 20, 22, there is a temperature drop that is followed by an immediate increase in temperature as the SCWO reactor 12 reaches the desired reaction temperature. Importantly, the temperature decrease is largely localized, and only impacts the portion of the SCWO reactor 12 immediately following the feedstock tees 16, 18, 20, 22. In turn, the precipitates within the SCWO reactor 12 do not redissolve within the fluid flowing in the SCWO reactor 12, as the temperature drop is not for a sufficient length of the SCWO reactor 12 to cause the particulates to dissolve.

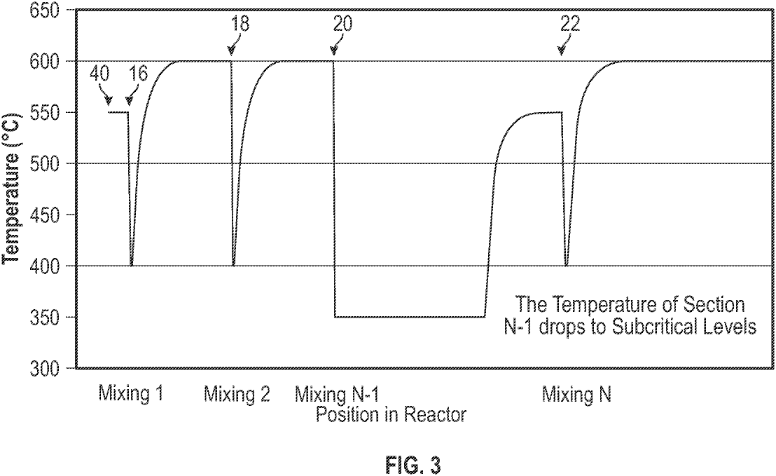

In contrast, FIG. 3 depicts a graph which shows the nominal temperature profile in a SWCO reactor 12 which does implement the CIP procedure by the present monitoring scheme and fouling reduction system 10. As illustrated in FIG. 3, the CIP procedure is triggered at the feedstock tee 20. Accordingly, a section within the SCWO reactor 12 following the feedstock tee 20 is at a reduced temperature compared to the remainder of the SCWO reactor. In turn, the precipitates within the SCWO reactor 12 are able to dissolve within the fluid flowing through the SCWO reactor, thereby reducing fouling. While FIG. 3 depicts the CIP procedure being implemented at feedstock tee 20, it is understood that any of the feedstock tees other than the final feedstock tee 22 may be used for implementing the CIP procedure.

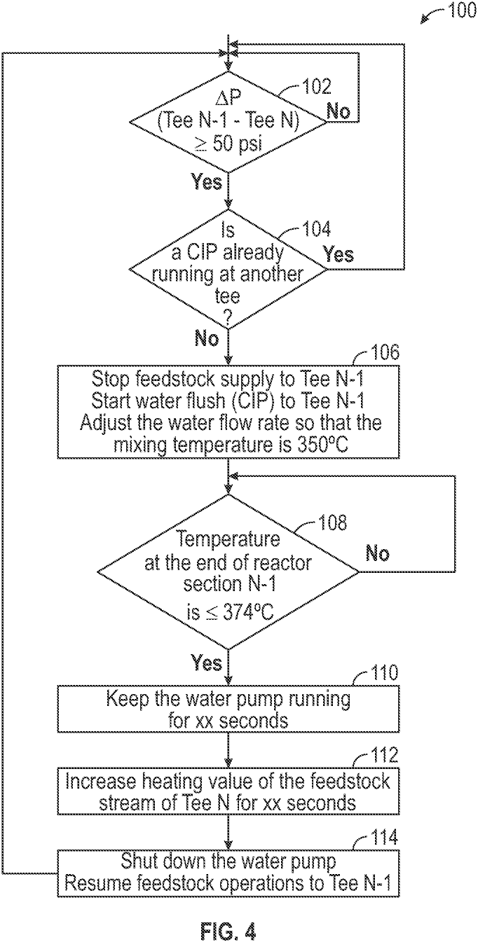

FIG. 4 depicts a decision flow diagram showing a method 100 for operating the present monitoring scheme and fouling reduction system 10. While FIG. 4 depicts an example decision flow diagram implementing method 100 for adjacent section following feedstock tees 16, 18, 20, 22 within the SCWO reactor 12, it is understood that the same decision flow diagram applies for comparison between any two feedstock tees 16, 18, 20, 22, comparison between one of the feedstock tees 16, 18, 20, 22 and the SCWO reactor outlet and comparison between one of the feedstock tees 16, 18, 20, 22 and the SCWO reactor 12 inlet. Additionally, ΔP (Tee N-1 - Tee N) denotes the pressure differential between the feedstock tee 20 and the feedstock tee 22.

In particular, the method 100 begins with step 102, where the controller 36 determines whether there is a pressure difference between feedstock tee 20 and feedstock tee 22 of greater than 50 PSI. While FIG. 4 depicts the pressure difference between feedstock tee 20 and feedstock tee 22 as 50 PSI, it is understood that different values for the pressure difference are appropriate for triggering the CIP procedure as is known in the art.

Once the controller 36 determines that the pressure difference between the feedstock tee 20 and feedstock tee 22 is greater than 50 PSI, the controller 36 proceeds to step 104 of the method 100, where the controller 36 determines whether a CIP procedure is already in place at a different feedstock tee 16, 18, 20, 22. If another CIP procedure is already in place at a different feedstock tee 16, 18, 20, 22, then the controller 36 does not initiate another CIP procedure until the current CIP procedure finishes. Waiting until the current CIP procedure finishes helps limit the impact of CIP procedures on the operation of the SCWO reactor 12.

However, if there are no CIP procedures in progress, the method 100 proceeds to step 106, where the controller 36 stops feedstock 14 supply to the feedstock tee 20 and provides the water 28 to the feedstock tee 20. Further, the flow rate of the water 28 is adjusted by the flow regulating device 64 so that the mixing temperature within the SCWO reactor 12 is approximately 350° C. Any appropriate fluid is optionally used in place of the water 28 for the CIP procedure as is known in the art. For example, the fluid used in the CIP procedure is optionally water 28 mixed with the optional additive 32.

Then in step 108, the controller 36 measures the temperature at the end of the SCWO reactor 12 section following the feedstock tee 20 to determine whether the temperature is less than 374° C. While the step 108 preferably determines whether the temperature is less than 374° C., any temperature in the range of 200° C.-500° C. is appropriate to use as the threshold temperature for the step 108.

Once it is determined that the temperature at the end of the SCWO reactor 12 section following the feedstock tee 20 is below 374° C., the method 100 proceeds to step 110, where water 28 is provided to the SCWO reactor 12 for a predetermined amount of time. Additionally, the method 100 includes the optional step 112 of supplying co-fuel 24 to feedstock tee 22 to compensate for the reduced temperature following feedstock tee 20 caused by the CIP procedure.

Finally, the method 100 advances to step 114, where the water 28 is no longer provided to the SCWO reactor 12, and the feedstock tee 20 resumes providing feedstock 14 to the SCWO reactor 12. By the method 100, the present monitoring scheme and fouling reduction system 10 reduces fouling within the SCWO reactor 12.

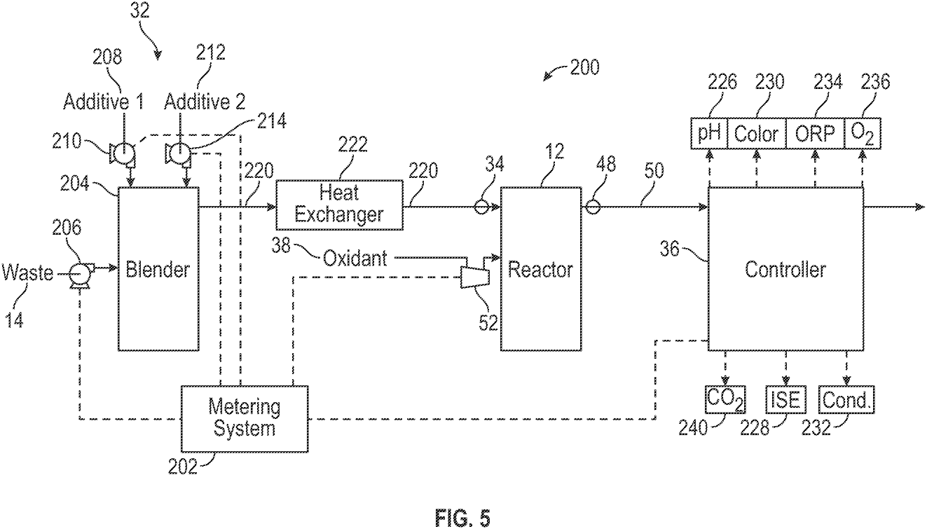

Referring now to FIG. 5, another embodiment of the present monitoring scheme for corrosion and fouling control for SCWO systems is generally designated 200 and includes the SCWO reactor 12 and a metering system 202. Components shared with the monitoring scheme for corrosion and fouling control for SCWO systems 10 are designated with identical reference numbers. Oxidants 38 are supplied to the SCWO reactor 12, optionally by the compressor 52. While the present SCWO system 200 preferably includes a SCWO MFI reactor 12, it is understood that any SCWO reactor is optionally used within the system 200.

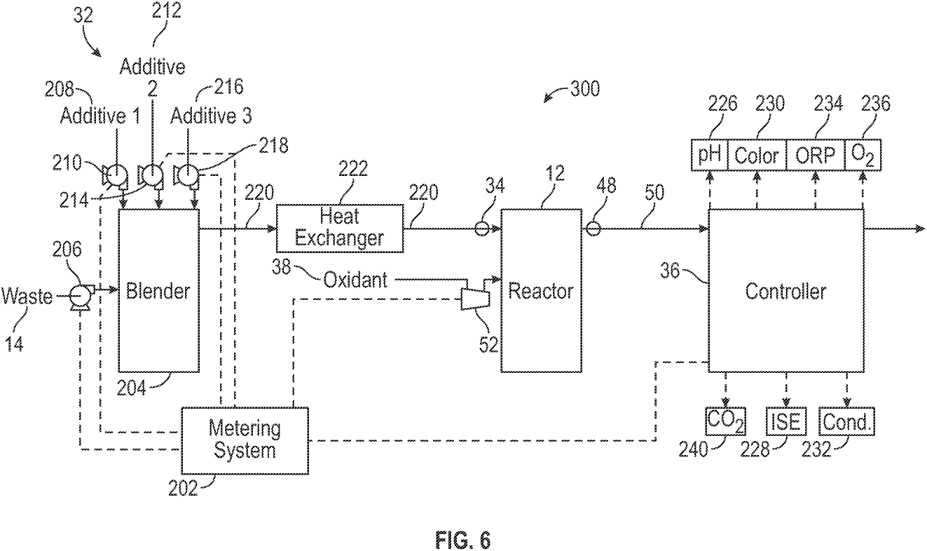

Additionally, a blender 204 blends a waste feedstock 14 supplied by a feedstock supply regulator 206 as well as the optional additive 32. As depicted in FIG. 5, the optional additive 32 optionally includes at least one of a first additive 208 supplied by a first supply regulator 210 and a second additive 212 supplied by a second supply regulator 214. Referring to FIG. 6, yet another embodiment of the present monitoring scheme for corrosion and fouling control for SCWO system 200 is generally designated 300. Components of the system 300 shared with the monitoring scheme for corrosion and fouling control for SCWO systems 200 are designated with identical reference numbers.

The metering system 202 regulates the operation of the feedstock supply regulator 206, the first supply regulator 210, and the second regulator 214 to adjust the amount of the feedstock 14, first additive 208 and second additive 212 supplied to the blender 204, respectively. A main distinctive feature of the SCWO system 300 is that a third additive 216 is supplied by a third supply regulator 218 to the blender 204. The blender 204 optionally includes either a mixer or a static mixer, so that the first, second, and third additives 208, 212, 216 and the feedstock 14 are thoroughly mixed to form a stable and homogenous mixture. Within the corrosion and fouling reduction system 300, the metering system 202 also regulates the operation of the third supply regulator 218 to adjust the amount of the third additive 216 supplied to the blender 204. Preferably, the optional third additive 216 is provided to the blender 204 when the feedstock 14 has a low viscosity, as the third additive 216 helps improve the efficiency of the system 300 by providing a stable and homogenous feed to the SCWO reactor 12. Preferably, the stable and homogenous feed is a stable and homogenous slurry feed which is provided to the SCWO reactor 12.

While two combinations of the first, second and third additives 208, 212, 216 are illustrated, it is understood that any combination which includes at least one of the first, second and third additives 208, 212, 216 is appropriate as is known in the art. The combination of the first, second and third additives 208, 212, 216, as well as the feedstock 14, are mixed by the blender 204 to form a SCWO reactor input 220.

Further, the SCWO reactor input 220 is optionally fed into an SCWO reactor input heat exchanger 222, which transfers heat to the SCWO reactor input 220 prior to reaching the SCWO reactor 12. Moreover, a pH of an SCWO reactor effluent 50 is collected by a pH sensor 226 and relayed to the controller 36 which controls the metering system 202 to adjust the amount of the first, second, and third additives 208, 212, 216 supplied to the blender 204. Optionally, the controller 36 also receives data from an ion selective electrode (ISE) sensor 228, a color sensor 230 such as a spectrophotometric analyzer, conductivity probes 232, an oxidation reduction potential (ORP) sensor 234, inlet reactor pressure sensor 34, outlet reactor pressure sensor 48, and/or an oxygen sensor 236. This received date is used by the controller 36 which controls the metering system 202 to adjust the amount of the first, second, and third additives 208, 212, 216 supplied to the blender 204.

In particular, the first additive 208 is a neutralizing agent, which reduces the acidity of the feedstock 14 and/or the effluent 50. The feedstock 14 often includes organic compounds with chloride atoms, such that during the oxidation process within the SCWO reactor 12, the chloride atoms react to form hydrochloric acid. As such, the effluent 50 would be acidic even though the feedstock 14 was not acidic. Accordingly, the first additive 208 is used to reduce the acidity of the feedstock 14 and/or the effluent 50.

Specifically, the first additive 208 is a base, which preferably includes a blend of soluble and/or insoluble minerals, such as finely powdered or solubilized alkaline metals or alkaline-earth metals species. In a preferred embodiment, the first additive 208 includes: at least one metal oxide, such as CaO, MgO, or K₂O; at least one hydroxide, such as Ca(OH)₂, Mg(OH)₂, or KOH; at least one metal carbonate, such as CaCO₃, MgCO₃, or K₂CO₃; at least one metal phosphate, such as Ca₃(PO₄)₂ or Mg₃(PO₄); or combinations thereof. Any base which reduces the acid content in the feedstock 14 and/or the effluent 50 is appropriate for use in the first additive 208.

Chemical formula (1) illustrates how the first additive 208 reduces the acidity of the feedstock 14 and/or the effluent 50.

$$2 \text{HF} \text{+} {Μ}_{\text{x}} \left({\text{CO}}_{3}\right) \to {\text{M}}_{\text{x}} {\text{F}}_{2} + {\text{CO}}_{2} + {\text{H}}_{2} \text{O}$$

In particular, the feedstock 14 and/or the effluent 50 illustrated by chemical formula (1) includes hydrofluoric acid. Accordingly, the first additive 208, which is a metal carbonate (Mₓ(CO₃)), reacts with the hydrofluoric acid to form a metal fluoride (MₓF₂), carbon dioxide and water. In this way, the acidity of the feedstock 14 and/or the effluent 50 has been reduced.

In another example, chemical formula (2) shows a metal hydroxide reducing the acid of the feedstock 14 and/or the effluent 50 caused by the presence of hydrofluoric acid.

$$2 \text{HF} \text{+} {\text{M}}_{\text{x}} {\left(\text{OH}\right)}_{2} \to {\text{M}}_{\text{x}} {\text{F}}_{2} + 2 {\text{H}}_{\text{2}} \text{O}$$

Specifically, the metal hydroxide (Mₓ(OH)₂) in the first additive 208 reacts with the hydrofluoric acid in the feedstock 14 and/or the effluent 50 to form a metal fluoride (MₓF₂) and water.

Similarly, the second additive 212 includes a blend of seeding nuclei, which create a large surface area for nucleation while also reducing the amount of the second additive 212 used for effective nucleation of the particles in the feedstock 14. Preferably, the particle size of the second additive 212 is in the sub-micron to few microns range, such as about 0.1 micron to about 10 microns. Additionally, the blend seeding nuclei in the second additive 212 is preferably in the form of suspended inert particles of metal oxides, such as silica SiO₂, iron oxide Fe₂O₃, metal sulfates (such as CaSO₄), alumina Al₂O₃ or silt (containing combinations of quartz, feldspars, chlorites and micas), but also finely powdered silicate minerals such as olivine and more broadly nesosilicates, as well as clay minerals. It is contemplated that any compound which offers an available, free moving surface area onto which salts attach when precipitating out of solution in the effluent 50 are appropriate for use as the second additive 212.

In a preferred embodiment, the second additive 212 is a compound which does not reduce the acidity of the feedstock 14. Additionally, the optional additive 32 includes any combination of the first, second, and third additives 208, 212, 216.

A preferred embodiment of the corrosion and fouling reduction system 200 includes adding the first and second additives 208, 212 to the blender 204. In particular, when the feedstock 14 and/or the effluent 50 includes acids, the first additive 208 reduces the acidity of the feedstock 14 and/or the effluent 50, while the second additive 212 provides seeding nuclei upon which the salts produced by the reaction of the feedstock 14 and the base in the first additive 208 can attach to. As is known in the art, when an acid and a base react, they form a salt and water. Accordingly, when the first additive 208 reduces the acidity of the feedstock 14 and/or the effluent 50, there is a resulting salt. In certain circumstances, this salt precipitates out of the fluid in the SCWO reactor 12 and causes fouling. The second additive 212 reduces this fouling. As such, the preferred embodiment includes both the first and second additives 208, 212.

The optional third additive 216 is a thickener which is preferably added to the blender 202 when insoluble particles are used in the first additive 208 and/or the second additive 212. Specifically, the third additive 216 is added to the blender 202 so that the SCWO reactor input 220 is a stable and homogenous slurry feed, so that the insoluble particulates in the first and second additives will not foul the SCWO reactor 12. Additionally, the optional additive 216 helps improves the metering of the first additive 208 and the second additive 212. Preferably, the third additive 216 is a starch, cellulose, guar gum or any organic compound that provides a thickening effect as is known in the art.

A preferred recipe for the additives 208, 212, 216 includes powdered calcium carbonate, powdered alumino silicates, Al₂SiO₅, clays such as kaolinite, bentonite, or polymeric carbohydrates such as starch. Preferably, the powder is ground to the sub-micron to micron range. In the preferred recipe, the first additive 208 is provided in an amount of between 1-20 g/L, the second additive 212 is provided in an amount of between 1-20 g/L, and the third additive 216 is provided in an amount of between 1-5 g/L.

Another important feature of the corrosion and fouling reduction system 10 is the metering system 202, which is a stand-alone system connected to the SWCO process that supplies the first, second, and third additives 208, 212, 216 to the blender 202. In particular, the metering system 202 includes-storage tanks (not shown) which house each of the first, second, and third additives 208, 212, 216 and flow regulators 210, 214, 218 which regulate the supply of the first, second, and third additives 208, 212, 216 to the blender 204. Moreover, the supply regulators 210, 214, 218 control the mass flow rate of the first, second, and third additives 208, 212, 216 to the blender 16 as is known in the art. For example, when the first, second, and third additives 208, 212, 216 are in fluid form, the supply regulators 210, 214, 218 are preferably fluid flow devices such as valves, pumps, or other devices which regulate the flow of fluid. Alternatively, when the first, second, and third additives 208, 212, 216 are in powder form, powder dosing systems are optionally used as is known in the art. Further, the first, second, and third additives 208, 212, 216 are optionally combined and blended with liquid separately and the blend is then mixed with the feedstock 14.

While FIGS. 5-7 depict the additives 208, 212, 216 being supplied to the blender 16, it is also contemplated that the additives 208, 212, 216 are optionally supplied to the SCWO reactor 12 through a side stream (not shown) that is optionally added to the SCWO reactor 12 in several locations, including an inlet of the SCWO reactor 12, or directly upstream, inside or downstream of the SCWO reactor 12.

Additionally, the flow of the feedstock 14 is controlled by the feedstock supply regulator 206, which is preferably a valve, pump, or other device which regulates the flow of fluid and is connected to the controller 36. In a preferred embodiment, the feedstock supply regulator 206 is a variable flow rate pump. As discussed in greater detail below, the controller 36 analyzes data from the sensors 34, 48, 226, 228, 230, 232, 234, 236 and communicates with the metering system 202 which adjusts the mass flow rate for each of the oxidant 38, the feedstock 14 and the first, second, and third additives 208, 212, 216. The metering system 202 operates the flow regulators 210, 214, 218 in either a continuous or intermittent fashion as is known in the art. Additionally, the sensors 34, 48, 226, 228, 230, 232, 234, 236 provide real time information to the controller 36, such that the controller 36 is able to communicate with the metering system 202 in real time to quickly adjust the flow regulators 210, 214, 218 based on changes in the feedstock 14 and/or the effluent 50.

The pH sensor 226 monitors the effectiveness of the first additive 208 in reducing the acidity of the feedstock 14 and/or the effluent 50. More specifically, the pH is optionally set within a control loop, for example above a pH of 6, such that when the controller 36 determines that the pH of the SCWO reactor effluent 50 begins to drop below a pH of 6, the controller 36 causes the metering system 202 to supply a greater quantity of the first additive 208 to the blender 204. Conversely, if the pH of the SCWO reactor effluent 50 begins to rise above a predetermined maximum pH, the controller causes the metering system 202 to reduce the supply of the first additive 208 to the blender 204. In a preferred embodiment, as the metering system 202 either increases or decreases the supplied first additive 208, the supplied second and third additives 212, 216 are increased or decreased proportionally.

Many SCWO reactors contain chromium. Certain chemicals which form the structure of the SCWO reactor 12, such as chromium, have an intrinsic color that is detected in the SCWO reactor effluent 50 using the color sensor 230. Unless the feedstock 14 contained these chemicals, such as chromium, then their presence in the reactor effluent 50 is indicative of corrosion. As is known in the art, Cr(O₄)^{2—} is a yellow dissolved chromium species, typically formed in SCWO reactor 12 when corrosion of chromium-containing materials occurs. Accordingly, when the color sensor 230 detects an indicative color related to corrosion, stemming from the presence of a particular chemical, such as Cr(O₄)²⁻, the controller 36 causes the metering system 202 to supply additional first additive 208 to counteract the corrosion.

Moreover, the ISE sensor 228 detects ions that are indicative of corrosion within the SCWO reactor 12. Specifically, the ISE sensor 228 monitors metal ions which form due to corrosion within the SCWO reactor 12 and provide this information to the controller 36. Specifically, if the SCWO reactor 12 contains nickel or chromium, the ISE sensor 228 would detect the presence of relevant compounds such as nickel ions or chromium ions. Then, the controller 36 communicates with the metering system 202 to increase the supply of the second additive 212 to counteract corrosion.

As is known in the art, fouling at any location in the SCWO reactor 12 will hinder the flow due to narrowing of the flow path and result in higher pressure drops within the SCWO reactor 12. This is detected by monitoring pressure differentials between selected locations known to be susceptible to fouling. For example, the inlet pressure sensor 34 is optionally located at the inlet of the SCWO reactor 12 and the outlet pressure sensor 48 is optionally located at the outlet of the SCWO reactor 12. Upon detecting that fouling has occurred, the controller 36 optionally causes the metering system 202 to supply an increased quantity of the second additive 212 to counteract the fouling within the SCWO reactor 12. While FIGS. 5-6 only show pressure sensor 34, 48, it is appreciated that any number of pressure sensors are optionally included at important locations within the SCWO reactor 12 as is known in the art.

The pressure sensors 34, 48 are used to compute pressure drops over relevant sections of the SCWO reactor 12 where fouling is likely to occur. Then, the measured pressure drops are compared to reference values of a clean unfouled SCWO reactor 12 by the controller 36. The pressure drops are optionally determined by virtual measurements derived from the pressure sensors 34, 48.

Further, fouling is monitored by the conductivity probes 232. Many of the chemical species which deposit onto surfaces of the SCWO reactor 12 and result in fouling are ionic species. Thus, monitoring electrical conductivity and comparison of the conductivity in real-time to reference values allows the controller 36 to detect deposition of chemical species onto surfaces. Accordingly, the controller 36 will increase the supply of the second additive 212 to counteract the fouling. While FIG. 5 only shows one conductivity probe 232, it is appreciated that any number of conductivity probes 232 are optionally included at important locations within the SCWO reactor 12 or within the SCWO system 200 upstream or downstream of the SCWO reactor 12 as is known in the art. The conductivity of the effluent stream 50 measured by the conductivity probes 232 is optionally used to monitor the total dissolved solids (TDS) within the SCWO reactor 12.

Another way of assessing fouling is through the monitoring of ORP with the ORP sensor 234. Many of the chemical species which cause fouling are redox active and result in changes in ORP. Thus, monitoring of ORP and comparison of the ORP in real-time to reference values allows the controller 36 to detect fouling. Accordingly, the controller 36 communicates with the metering system 202 to increase the supply of the second additive 212 to counteract the fouling.

The presence of CO₂ and the resulting formation of carbonic acid within the SCWO reactor 12 decreases the pH of the SCWO reactor effluent 50. In turn, there exists a risk of inaccurate pH readings by the pH sensor 226, in turn skewing the amount of the first additive 208 supplied by the metering system 202. As a result, it is preferred that the controller 36 is set with an acceptable pH range of 3-10, and preferably still an acceptable pH range of 4-8, where any pH recorded in the SCWO reactor effluent 50 outside of this range triggers addition or reduction in the quantity of the first additive 208 to the blender 204. Preferably still, the corrosion and fouling reduction system 200 includes a CO₂ sensor 240 which measures the CO₂ content of the SCWO reactor effluent 50. This CO₂ sensor improves the accuracy with which the controller 36 increases or decreases the quantity of the first additive 208 added to the blender 204.

It is preferred that the proper ratio of the first, second, and third additives 208, 212, 216 for any given feedstock 14 is predetermined through routine experimentation. Preferably still, the corrosion and fouling reduction system 300 automatically controls the ratio of the first, second, and third additives 208, 212, 216 to the feedstock 14 and adjust the supply of the first, second, and third additives 208, 212, 216 proportionally to the supply of feedstock 14. A preferred ratio of the first, second, and third additives 208, 212, 216 to the feedstock 14 is between around 1:100 and around 1:10. However, other ratios of the first, second, and third additives 208, 212, 216 to the feedstock 14 are contemplated.

Optionally, the color sensor 230, the ORP sensor 234, and/or the oxygen sensor 236 are used by the controller 36 to improve the ability of the metering system 202 to accurately supply the proper quantity of the first, second, and third additives 208, 212, 216 to the blender 202.

Additionally, the data obtained by the sensors 34, 48, 226, 228, 230, 232, 234, 236 are either direct measurements or proxy measurements. In particular, proxy measurements refer to measuring either the direct effect or the variables that are symptomatic of the fouling or corrosion. In either instance, the obtained data is optionally used to control the implementation of preventive actions meant to avoid or mitigate corrosion or fouling.

In a preferred embodiment, each the sensors 34, 48, 226, 228, 230, 232, 234, 236 operates on a separate control loop within the controller 36, such that data obtained by the sensors 34, 48, 226, 228, 230, 232, 234, 236 is used by the controller 36, which communicates with the metering system 202 to adjust the amount of additives 208, 212, 216, oxidant 38, and feedstock 14 supplied to the SCWO reactor 12. In one embodiment, the controller 36 weighs the data from each of the sensors 34, 48, 226, 228, 230, 232, 234, 236 equally. However, it is contemplated that the controller 36 optionally assigns different weight to the data measured by each of the sensors 34, 48, 226, 228, 230, 232, 234, 236.

Additionally, the controller 36 optionally has threshold values for each parameter measured by the sensors 34, 48, 226, 228, 230, 232, 234, 236, such that when the measured parameter exceeds the threshold value, the controller 36 operates the metering system 202 to counteract fouling or corrosion within the SCWO reactor 12.

Moreover, the controller 36 optionally uses moving average operations to reduce noise within the SCWO system 200, thereby reducing the chance of triggering unnecessary output by the controller 36. The use of threshold values and moving average operations are well known in the art.

For example, when the pressure drops determined by the pressure sensors 34, 48 exceed threshold values, the control loop for the pressure sensors 34, 48 will supply the measured pressure drops to the controller 36, such that the controller 36 institutes corrective action. It is understood that each of the sensors 34, 48, 226, 228, 230, 232, 234, 236 operates in a similar fashion to provide control loops for the various parameters of the SCWO system 200.

Importantly, additive 32 stream pressurization will take place upstream or downstream of the blender 204 prior to preheating within the SCWO reactor input heat exchanger 222. Additionally, it is contemplated that the feedstock 14, and each of the first, second, and third additives 208, 212, 216 are each optionally preheated by separate heat exchangers (not shown). Alternatively, the first, second, and third additives 208, 212, 216 are optionally mixed in a separate mixer (not shown) prior to reaching the blender 204.

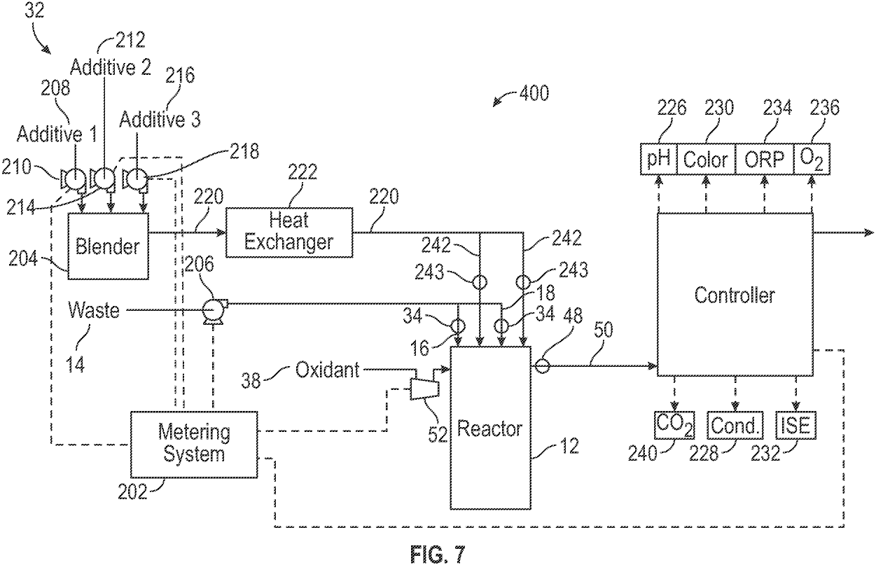

Referring to FIG. 7, another embodiment of the present monitoring scheme for corrosion and fouling control for SCWO system 200 is generally designated 400. Components shared with the monitoring scheme for corrosion and fouling control for SCWO systems 200 are designated with identical reference numbers.

The first, second, and third additives 208, 212, 216 are added to the blender 204, and the mixture of the first, second, and third additives 208, 212, 216 is supplied to the SCWO reactor 12 at various points within the SCWO reactor 12. While FIG. 7 depicts the first, second, and third additives 208, 212, 216 being supplied to the blender 204, it is understood that any combination of the first, second, and third additives 208, 212, 216 is optionally added to the blender 204.

In particular, the additive supply tees 242 supply the additives 208, 212, 216 from the blender 204 to the SCWO reactor 12. Similarly, feedstock tees 16, 18 provide the feedstock 14 to the SCWO reactor 12. While only two feedstock tees 16, 18 and two additive supply tees 242 are depicted in FIG. 7, it is understood that greater or fewer feedstock tees 16, 18 and additive supply tees 242 are optionally utilized in the corrosion and fouling reduction system 400. Additionally, the number of feedstock tees 16, 18 is optionally different from the number of additive supply tees 242. Optionally included is the SCWO reactor input heat exchanger 222 which transfers heat to the first, second, and third additives 208, 212, 216 before reaching the SCWO reactor 12.

The addition of the optional third additive 216 makes the supplied additives 32 easier to meter since the additives 32 are blended separately before being added to the feedstock 14.

The feedstock tees 16, 18 and the additive supply tees 242 are designed to supply the feedstock 14 and the first and second additives 208, 212 to the SCWO reactor 12 such that the feedstock 14 and the first and second additives 208, 212 form a homogeneous mixture within the SCWO reactor 12. Specifically, the location and number of the feedstock tees 16, 18 and the additive supply tees 242 are selected to allow for proper mixing and high turbulence of the feedstock 14 and the first and second additives 208, 212 thereby dispersing the first and second additives 208, 212 throughout the feedstock 14.

Moreover, the feedstock 14 and oxidant 38 preferably achieve a sufficiently high velocity within the SCWO reactor 12, preferably within the range of 0.2 m/s and 10 m/s, and preferably still within the range of 1 m/s and 5 m/s. By achieving this sufficient velocity, the fluid flowing within the SCWO reactor 12 achieves proper transportation and fluidization of the inert solids within the SCWO reactor 12.

Further, the corrosion and fouling reduction system 400 includes the pressure sensors 34 in the feedstock tees 16, 18. Also, additive pressure sensors 243 are located in the additive supply tees 242.

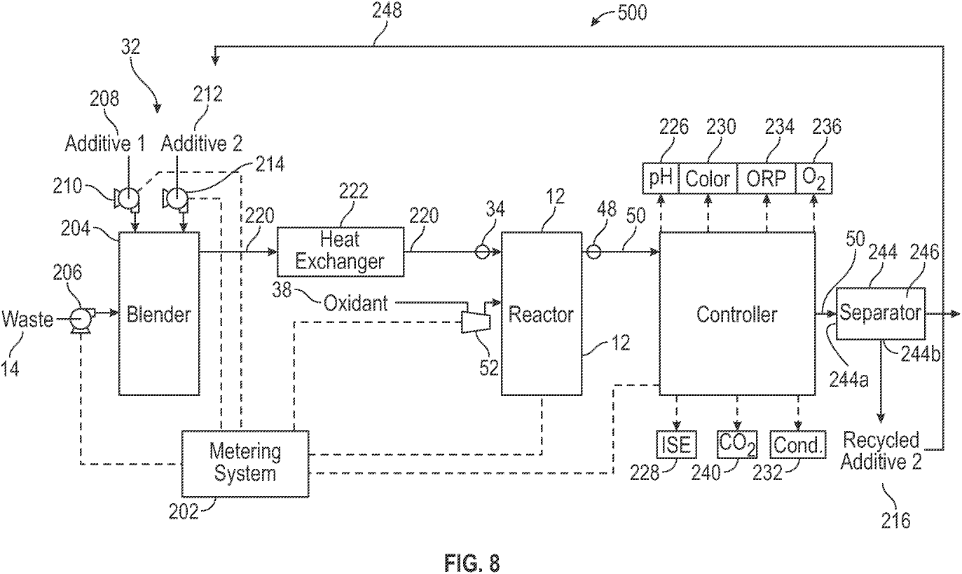

Further, FIG. 8 illustrates another embodiment of the corrosion and fouling reduction system 500, which includes a separator 244 that recovers and recycles the second additive 216 from the SCWO reactor effluent 50. Components shared with the corrosion and fouling reduction system 200 are designated with identical reference numbers. Specifically, the second additive 216 within the SCWO reactor effluent 50 becomes coated 246 with salts or the like during reaction. In certain situations, the coating 246 is readily dissolved in the SCWO reactor effluent 50 once the temperature drops to subcritical levels, typically below 340° C. In this case, the coating 246 dissolves into the SCWO reactor effluent 50, meaning second additive 216 will no longer have the coating 246 and is recyclable.

The separator 244 separates the liquid SCWO reactor effluent 50 from the solid second additive 216, and the second additive 216 is recycled. However, the coating 246 is often either insoluble or only slightly soluble. For the situation where the coating 246 is either insoluble or only slightly soluble, additional processing is required to recycle the second additive 216 so that it is reused by the corrosion and fouling reduction system 500. More specifically, the separator 244 includes a physical separation device 244a and a classification device 244b. The classification device 244b determines which particles of the second additive 216 are reusable. Additionally, the classification device 244b determines whether the second additive 216 with the coating 246 is reusable. As a result, either the recycled second additive 216 is provided to the second additive storage tank (not shown) or fresh second additive 216 is supplied to the second additive storage tank.

In particular, the classification device 244b determines which particles of the second additive 216 are recyclable based on whether the particles reach a target diameter or specific gravity. When the particles are greater than the target diameter or specific gravity, then the second additive 216 is not recyclable, and the second additive 216 is discarded. When the particles are less than the target diameter or specific gravity, the second additive 216 is recyclable, and is sent to the second additive 216 storage tank (not shown) by way of a recycled second additive supply line 248. For situations where the coating 246 cannot be removed from the second additive 216, it is still possible to second additive 216 with the coating 246 is recyclable for use as the second additive 216 so long as the second additive 216 with the coating 246 is less than the target diameter or specific gravity.

The separation device 244a uses a filter, hydrocyclone or other device for physically separating suspended particles based on size exclusion or specific gravity as is known in the art. Additionally, alternative post treatment methods of the SCWO reactor effluent 50 are envisioned, such as mild acid redissolution, if recovering the salt coatings 246 is of interest. Further, using coagulation and flocculation agents within the separation device 244a to facilitate the separation of small particles is also contemplated. Moreover, milling the recycled second additive 216 is also considered, as doing so would reduce the particle size of the second additive 216, thereby improving the surface area to volume ratio of the second additive 216 facilitating its recycling.

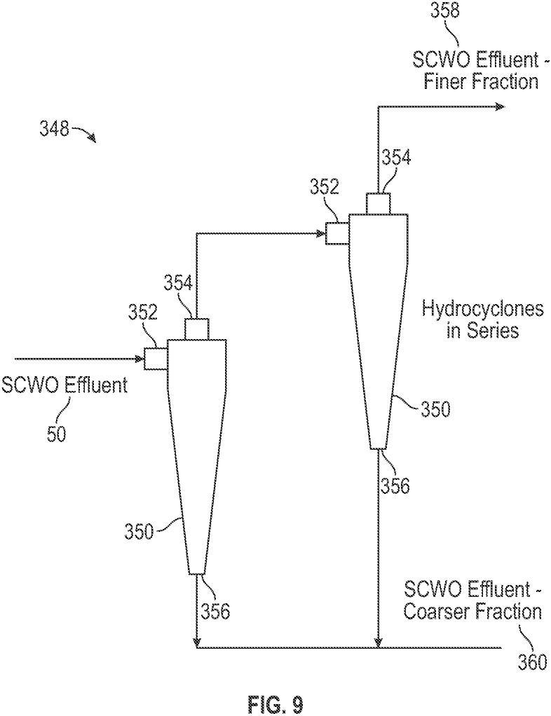

FIG. 9 shows an alternate embodiment of the separator 348 which includes two hydrocyclones 350 in series. Components shared with the separator 248 are designated with identical reference numbers. Specifically, the SCWO reactor effluent 50 enters the first hydrocyclone 350 through a hydrocyclone inlet 352. Additionally, the fine particles from the SCWO reactor effluent 50 exit through a hydrocyclone fine particle outlet 354. Moreover, the coarse particles of the second additive 216 exit through a hydrocyclone coarse particle outlet 356. Further, the fine particle outlet 354 of the first hydrocyclone 350 is directed toward the hydrocyclone inlet 352 for the second hydrocyclone 350. Therefore, the fine particles of the SCWO reactor effluent 50 pass through both hydrocyclones 350, such that the SCWO reactor effluent 50 forms a SCWO reactor fine effluent 358 and a SCWO reactor coarse effluent 360. Other separation technologies, such as centrifuges, are optionally used by the separator 244 as are known in the art.

While a particular embodiment of the present system and method of corrosion and fouling reduction for a SCWO system has been described herein, it will be appreciated by those skilled in the art that changes and modifications may be made thereto without departing from the invention in its broader aspects and as set forth in the following claims.

1. A SCWO reactor fouling prevention and mitigation system, comprising:
at least one feedstock tee which provides a feedstock to said SCWO reactor;
at least one feedstock tee pressure sensor, such that each said at least one feedstock tee has one of said at least one feedstock tee pressure sensor;
at least one pressure sensor proximate a SCWO reactor inlet;
at least one pressure sensor proximate a SCWO reactor outlet; and
a controller which triggers a Clean In Place (CIP) procedure when there is a pressure difference between any two of the following:
said SCWO reactor inlet;
said at least one feedstock tee; and
said SCWO reactor outlet;
wherein said CIP procedure comprises washing a portion of said SCWO reactor with a fluid supplied through said at least one feedstock tee.

2. The system of claim 1, wherein said at least one feedstock tee includes four feedstock tees and said at least one pressure sensor includes four pressure sensors.

3. The system of claim 1, wherein said washing fluid is water.

4. The system of claim 1, further comprising:
at least one additive supplied through said at least one feedstock tee, said at least one additive comprising at least one of:
a neutralizer for reducing the acidity within said SCWO reactor;
a blend of seeding nuclei for particulates to attach to within said SCWO reactor; and
a thickener for maintaining a stable and homogenous feed into said SCWO reactor.

5. The system of claim 4, further comprising:
a metering system connected to said controller which controls the supply of said at least one additive to said at least one feedstock tee, said metering system comprising:
at least one sensor selected from a group of sensors including: pressure sensor, pH sensors, color sensors, Oxidation Reduction Potential (ORP) sensors, Ion Selective Electrode (ISE) sensors, conductivity probes, CO₂ sensors, and/or oxygen sensors; and
a flow regulator for each of said at least one additive, wherein said flow regulator adjusts the amount of said at least one additive to said at least one feedstock tee based on the data received from said at least one sensor.

6. The system of claim 4, further comprising:
a blender upstream of said at least one feedstock tee, wherein said blender mixes said at least one additive with said feedstock prior to reaching said SCWO reactor.

7. The system of claim 6, further comprising a heat exchanger located between said blender and said SCWO reactor which preheats said at least one additive and said feedstock.

8. The system of claim 2, wherein any of said feedstock tees downstream of said feedstock tee where said CIP procedure is taking place receives a co-fuel to increase the heating value within said SCWO reactor downstream of the location of said CIP procedure unless the CIP procedure takes place at said feedstock tee nearest said outlet of said SCWO reactor.

9. A method of corrosion and fouling reduction for a SCWO system, comprising:
providing a feedstock to a SCWO reactor;
introducing at least two additives into said SCWO reactor, said at least two additives comprising:
a neutralizer for reducing the acidity within said SCWO reactor;
a blend of seeding nuclei for particulates to attach to within said SCWO reactor; and
a thickener for maintaining a stable and homogenous feed into said SCWO reactor;
measuring, with at least one sensor, at least one parameter of said SCWO reactor; and
adjusting the amount of said at least two additives into said SCWO reactor based on said parameter.

10. The method of claim 9, further comprising:
separating, with a separator, said seeding nuclei from said particulates; and
recycling said seeding nuclei.

11. The method of claim 10, wherein said separator includes at least one hydrocyclone.

12. The method of claim 9, further comprising:
washing a portion of said SCWO reactor, said washing comprising:
measuring the pressure at two locations within said SCWO reactor;
determining, based on the measured pressure, whether the pressure drop exceeds a threshold value; and
introducing a washing fluid to reduce the temperature within said portion of said SCWO reactor.

13. The method of claim 9, wherein said feedstock and said at least two additives are provided to said SCWO reactor by at least two feedstock tees, which are evenly spaced along the length of said SCWO reactor.

14. The method of claim 9, wherein said at least one parameter comprises:
an ORP of a SCWO reactor effluent measured by an ORP sensor;
a pH of said SCWO reactor effluent measured by a pH sensor;
a color of said SCWO reactor effluent detected by a color sensor;
an oxygen content of said SCWO reactor effluent measured by an oxygen sensor;
a conductivity of said SCWO reactor effluent measured by a conductivity probe;
an ion content of said SCWO reactor effluent measured by an ISE sensor; and
a CO₂ content of said SCWO reactor effluent measured by a CO₂ sensor.

15. A SCWO multiple feeds injection (MFI) reactor fouling prevention and mitigation system, comprising:
a SCWO reactor;
at least one feedstock tee which provides a feedstock to said SCWO reactor;
a metering system, comprising:
at least one flow regulator which regulates the flow of at least one additive, said at least one additive comprising one of:
a neutralizer for reducing the acidity within said SCWO reactor;
a blend of seeding nuclei for particulates to attach to within said SCWO reactor; and
a thickener for maintaining a stable and homogenous feed into said SCWO reactor; and
at least one sensor, said at least one sensor relays measured data to a controller which communicates with said metering system to control said at least one flow regulator.

16. The system of claim 15, wherein said at least one sensor comprises:
an ORP sensor which measures an ORP of a SCWO reactor effluent;
a pH sensor which measures a pH of said SCWO reactor effluent;
a color sensor which detects a color of said SCWO reactor effluent;
an oxygen sensor which measures an oxygen content of said SCWO reactor effluent;
a conductivity probe which measures a conductivity of said SCWO reactor effluent;
an ISE sensor which measures an ion content of said SCWO reactor effluent; and
a CO₂ sensor which measures a CO₂ content of said SCWO reactor effluent.

17. The system of claim 15, further comprising:
a controller which triggers a Clean In Place (CIP) procedure when there is a pressure difference between any two of the following:
an inlet of said SCWO reactor;
said at least one feedstock tee; and
an outlet of said SCWO reactor;
wherein said CIP procedure comprises washing a portion of said SCWO reactor with a fluid supplied through said at least one feedstock tee.

18. The system of claim 15, further comprising:
a separator which separates said seeding nuclei from said particulates.

19. The system of claim 15, further comprising at least one heat exchanger which preheats at least one of:
said at least one additive; and
said feedstock.

20. The system of claim 15, wherein said at least one feedstock tee includes four feedstock tees and said at least one pressure sensor includes four pressure sensors; wherein said CIP procedure takes place at one of said four feedstock tees other than said feedstock tee nearest said outlet of said SCWO reactor; and wherein said feedstock tee immediately downstream of said feedstock tee where said CIP procedure is taking place receives a co-fuel to increase the heating value within said SCWO reactor downstream of the location of said CIP procedure.
